(19) United States
(12) Patent Application Publication
(10) Pub. No.: US 2006/0198860 A1
(43) Pub. Date: Sep. 7, 2006

(54) Synergistic blends of monoterpenes for mountain pine beetle pheromones

(75) Inventors: John H. Borden, Burnaby (CA); Deepa S. Pureswaran, Lansing, MI (US)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Phero Tech Inc., Delta (CA)

(21) Appl. No.: 11/368,507

(22) Filed: Mar. 7, 2006

Related U.S. Application Data
(60) Provisional application No. 60/658,601, filed on Mar. 7, 2005.

(51) Int. Cl. A01N 35/00; A01N 31/00

(52) U.S. Cl. 424/405; 514/690; 514/729

(57) ABSTRACT

This invention relates to compositions and methods of using blends of two or more monoterpenes as synergists for attractive pheromones of the mountain pine beetle, Dendroctonus ponderosae. When deployed in effective amounts in traps, on pine trees or in the vicinity of pine trees, these blends will increase the numbers of mountain pine beetles captured or attracted, compared to the numbers responding when a single monoterpene is used as a synergist.

### REFERENCE TO RELATED APPLICATION

This application claims the benefit of the filing date of U.S. provisional patent application Ser. No. 60/658,601, filed 7 Mar. 2005.

### FIELD OF THE INVENTION

This invention relates to methods and compositions for improving the management of the mountain pine beetle using semiochemicals. In particular, because blends of two or more monoterpenes will act as better synergists for attractive mountain pine beetle pheromones than any monoterpene used alone, more beetles will be attracted to the composition, and management of infestations will be improved.

### BACKGROUND OF THE INVENTION

Research on attractive semiochemicals for the mountain pine beetle, Dendroctonus ponderosae Hopkins, dates back to Pitman et al. (1968) who identified the pheromone trans-verbenol in the hindguts of female beetles. A blend of trans-verbenol with fresh resin from ponderosa pine, Pinus ponderosa, was attractive in baited traps to flying beetles in a ponderosa pine forest, but neither constituent was attractive alone (Pitman and Vité 1969). As in ponderosa pine, trans-verbenol was not attractive alone in stands of lodgepole pine, Pinus contorta var. latifolia (Conn et al. 1983). However, it was moderately attractive alone in a white pine forest (Pitman 1971). Rudinsky et al. (1974) discovered a male-produced pheromone, exo-brevicomin. At low concentrations in a field trapping experiment, exo-brevicomin synergized the response by flying mountain pine beetles to Pondelure, a 90:10 blend of trans-verbenol and the host tree monoterpene α-pinene.

As indicated below, numerous attempts have been made in field trapping studies to identify individual monoterpenes, or blends of monoterpenes that act as synergists for trans-verbenol or a combination of trans-verbenol with exo-brevicomin.

Pitman (1971) found that a blend of trans-verbenol with α-pinene was 1.4 times more attractive than a blend of trans-verbenol and camphene, and twice as attractive as a blend of trans-verbenol and myrcene. However, trans-verbenol was not tested alone in the same experiment as the blends, so the degree of synergism, if any, could not be determined. Moreover, the experiment was unreplicated, precluding the use of statistical analysis, and the release rate of the monoterpenes was undetermined. Therefore Pitman's (1971) results are not reliable.

Similarly, McKnight (1979) tested trans-verbenol in combination with individual monoterpenes, but did not evaluate synergism by testing either trans-verbenol or the monoterpenes alone in the same experiments as the combinations. He found that in stands of western white pine, Pinus monticola, the combinations of trans-verbenol with either myrcene or (+)-α-pinene were more attractive than the combination with (−)-α-pinene. In lodgepole pine stands, the beetles did not discriminate between the two enantiomers of α-pinene (myrcene was not tested), and in ponderosa pine stands, combinations with (+)-α-pinene and myrcene were superior to (−)-α-pinene.

In a true test of synergism, Billings et al. (1976) compared trans-verbenol alone or with each of six monoterpenes, with each monoterpene released at an estimated 48 mg per day at 21° C. In this experiment, in a lodgepole pine forest, traps baited with blends of trans-verbenol plus myrcene, terpinolene or 3-carene captured mountain pine beetles at respective rates 8.8, 4.6 and 4.1 times that of traps baited with trans-verbenol alone, but only the former two treatments resulted in catches significantly higher than in unbaited traps. In another experiment, traps baited with blends of Pondelure plus terpinolene or myrcene captured beetles at respective rates 4.7 and 4.2 times that in traps baited with Pondelure plus α-pinene. Because Pondelure contains 10% α-pinene, adding any monoterpene to it results in a binary terpene blend, but it is impossible to evaluate the combined effect definitively, because the release rates of the respective monoterpenes cannot be compared, and in the case of Billings et al. (1976), no comparison was made between the response to trans-verbenol alone and with any binary blend. Similarly, Libbey et al. (1985) found a blend of trans-verbenol plus myrcene to be almost twice as attractive to male mountain pine beetles in baited traps as a blend of trans-verbenol plus α-pinene, but none of the components was tested alone.

Conn et al. (1983) conducted an experiment in a lodgepole pine forest that documented another case of true synergism between a monoterpene and trans-verbenol. In this experiment traps baited with 3-carene released at an estimated rate of 7.0 mg per day combined with trans-verbenol released at the same rate captured 50 and 29 male and female mountain pine beetles, respectively, whereas traps baited with trans-verbenol or 3-carene alone caught no beetles and one female, respectively. In a second experiment combinations of trans-verbenol plus myrcene or a blend of myrcene, terpinolene, β-phellandrene, 3-carene, α-pinene and β-pinene caught 263 and 47, and 111 and 51 males and females, respectively. These were the only two treatments that resulted in catches of males and both sexes combined that were significantly higher than in unbaited control traps; combinations of trans-verbenol with any of the other four monoterpenes did not result in similar significant differences. Synergism between trans-verbenol and myrcene or the six-component blend is suggested, but not proven, by these results. In a concurrent experiment with semiochemical-baited lodgepole pines, again with monoterpene and trans-verbenol release rates estimated to be 7.0 mg per day, Borden et al. (1983) found that blends of trans-verbenol plus myrcene, or myrcene combined with another terpene alcohol, 3-caren-10-ol, resulted in a significantly higher proportion of trees attacked by the mountain pine beetle than trees in which α-pinene was substituted for myrcene. Adding exo-brevicomin released at 1.3 mg per day to tree baits also comprising trans-verbenol, 3-caren-10-ol and 3-carene resulted in a significantly higher proportion of trees attacked and a significantly higher attack density than when exo-brevicomin was absent.

Although synergism for myrcene was not proven by Conn et al. (1983) for trap baits or by Borden et al. (1983) for tree baits, Borden et al. (1986, Canadian Patent No. 1212044) claimed a blend of trans-verbenol, exo-brevicomin and myrcene as an effective bait for attracting mountain pine beetles to traps and inducing attack on baited trees. Borden et al. (1987) subsequently showed that raising the release rate of myrcene from 18 mg per day to 150 mg per day resulted in more than doubling the numbers of both sexes of beetles captured in traps also baited with trans-verbenol and exo-brevicomin. Borden et al. (1993) demonstrated that myrcene was not needed in tree baits, because the tree releases monoterpenes on its own after initial attack is induced by trans-verbenol and exo-brevicomin. However, for trap baits myrcene released at approximately 100 mg per day has become the industry standard for achieving synergism of response to trans-verbenol and exo-brevicomin (Phero Tech Inc., Delta, B.C.).

The question of releasing monoterpenes at different doses in combination with trans-verbenol (13% cis isomer) and exo-brevicomin released at 1.7 and 1.0-1.5 mg per day, respectively, was examined in field trapping experiments in lodgepole pine forests by Miller and Borden (2000). Different monoterpenes were released at five doses, ranging from less than 1.0 mg per day to over 6.0 g per day. In contrast to Billings et al. (1976) and Conn et al. (1983), there was no combination of terpinolene with trans-verbenol and exo-brevicomin that resulted in higher catches than to the pheromones alone, and at the highest dose (2.1 g per day), the response was significantly lowered. Similarly, there was no dose-response relationship with either α-pinene or β-pinene, and at no dose was the catch significantly different from that in pheromone-baited control traps. For β-phellandrene, the predominant monoterpene in lodgepole pine, the principal host of the mountain pine beetle, there was a significant (but very weak) relationship between dose and number of beetles captured, but at no dose was the catch significantly higher than to the pheromone control. There was no significant dose-response relationship for γ-terpinene, but at doses of 51.7 mg per day and 1.1 g per day, catches were significantly higher than to the pheromone controls. For both 3-carene and particularly myrcene there were significant dose-response relationships. At a dose of 600 mg per day catches with 3-carene added to the pheromones were higher than to the pheromones alone, and for myrcene catches at doses of 0.9 and 6.4 g per day were significantly higher than to the pheromones alone. While the doses required to achieve synergism were inexplicably higher than in other studies, this study did demonstrate synergism with γ-terpinene, 3-carene and myrcene. In a related study, Miller and Borden (1990) tested all possible combinations of β-phellandrene at three different doses (3.0, 40.0 and 450.0 mg per day) with ipsdienol (a pheromone of Ips species) at doses of 0.006, 0.060 and 0.6 μg per day. Traps baited with the lowest dose of ipsdienol (possibly below the response threshold for the mountain pine beetle) and the highest dose of β-phellandrene, captured almost half of the total catch of 1,090 beetles. This is the only suggestion of a monoterpene alone being attractive to the mountain pine beetle, without being in combination with trans-verbenol, exo-brevicomin, or both.

Seybold (2002) re-examined the synergistic capability of individual monoterpenes released from 17 ml plastic bottles (presumably at approximately 100 mg per day) in four Rocky Mountain locations. In each case the pheromone bait was trans-verbenol and exo-brevicomin released at approximately 1.5 and 0.3 mg per day, respectively. In all four locations, terpinolene was a better synergist than myrcene (almost 88 times better in one instance). Other monoterpenes showing apparent synergistic activity in one or more locations were: dipentene (contaminated with α-phellandrene, the principal monoterpene in lodgepole pine), 3-carene, (−)-β-pinene, (+)-α-pinene, (−)-α-pinene and myrcene. No statistical analysis was reported. In a subsequent experiment in the following year, myrcene and terpinolene were competitive with each other (S. Seybold, U.S. Forest Service, Davis, Calif., oral presentation to US Forest Service Bark Beetle Working Group, Homer Ak., 12-14 Oct. 2004).

Continuing the search for better synergism, Pureswaran (2003) and Pureswaran and Borden (2005), made up blends of monoterpenes that qualitatively and quantitatively mimicked those in naturally-occurring bole and foliage volatiles of lodgepole pine, by far the most common host of the mountain pine beetle. The synthetic blends in initial experiments included only compounds that comprised at least 5% of the total monoterpene complement. The bole blend included: (−)-α-pinene (5.4%), (−)-α-pinene (17.3%), (+)-3-carene (11.7%), (−)-β-phellandrene (46.8%), and (−)-limonene (6.0%). The foliage blend included: (−)-α-pinene (7.0%), (−)-β-pinene (44.6%), (−)-β-phellandrene (30.4%), and (+)-3-carene (7.4%). In three separate field trapping experiments, a pheromone bait comprising trans-verbenol and exo-brevicomin, released at approximately 1.5 and 0.3 mg per day, respectively, was tested in combination with the bole blend, the foliage blend or the bole plus the foliage blend. Each of the blends was released at approximately 140 mg per day. Myrcene released at approximately 100 mg per day was included as a monoterpene standard in each experiment. Only the foliage blend proved to be synergistic with the pheromones, resulting in three and five times more males and females captured, respectively, than to the pheromones alone. However, myrcene was over four times a better synergist than the foliage blend for males, and over three times better for females.

Pureswaran (2003) tested the hypothesis that more complete blends of lodgepole pine bole and foliage volatiles would be more bioactive than the above blends, which were limited to constituents that comprised at least 5.0% of the total volatile complement. Additional components were added in amounts ranging from 0.1% to 2.5% of the total blend. For both bole and foliage volatiles these were: (+)-α-pinene, (+)-β-pinene, (+)-limonene, terpinolene, (−)-camphene, (+)-sabinene, (−)-sabinene, and (−)-bornyl acetate. Further additions to the bole blend only were: camphene, α-terpinene and γ-terpinene, and p-cymene. (−)-Limonene was also added to the foliage blend. When tested in a lodgepole pine forest, neither the complete nor the simple blends provided effective synergism for trans-verbenol and exo-brevicomin, compared to the remarkable synergism afforded by myrcene.

In summary, the above research has shown the following.
1) Nine individual monoterpenes have been reported to have a synergistic effect on catches of the mountain pine beetle when combined with trans-verbenol alone or in combination with exo-brevicomin. These are: myrcene, terpinolene, 3-carene, (+)-α-pinene, (−)-α-pinene, β-pinene, γ-terpinene, camphene, and dipentene.
2) Despite some conflicting data, repeated positive results indicate that the evidence for synergism is strong only for myrcene, terpinolene, 3-carene and α-pinene. The evidence is clearly strongest for myrcene.
3) Only for β-phellandrene is there tentative evidence that any monoterpene might be attractive to the mountain pine beetle in the absence of its aggregation pheromones. Curiously, β-phellandrene has not been shown to have a synergistic effect in combination with pheromones, but its lack of availability has precluded extensive experimentation.
4) In three different studies, no blend of monoterpenes has proven to be a better synergist than any of the above monoterpenes alone.

Pureswaran (2003) contemplated what she called the myrcene enigma. Why, in her experiments, was myrcene a far better synergist for trans-verbenol and exo-brevicomin than simple or complex reconstituted blends of lodgepole pine monoterpenes, when lodgepole pine was the principal host of the mountain pine beetle? Because lodgepole pine sapwood oleoresin contains only 8.5% myrcene (Shrimpton 1973), Pureswaran (2003) searched the literature for other pines that were rich in myrcene and could represent preferred ancestral hosts for the beetle. The most likely candidate was whitebark pine, Pinus albicaulis (Smith 2000). On average, for three sampled populations, the sapwood oleoresin of whitebark pine contains 20.7% myrcene. Moreover, the other two predominant monoterpenes in whitebark pine oleoresin are 3-carene (60.8%) and terpinolene (6.6%); both of these compounds are among the group of four for which there is the strongest evidence of synergism (Point 2 above). We hypothesized that a reconstituted blend of whitebark pine sapwood monoterpenes, or some binary or ternary composition of the three predominant monoterpenes in that oleoresin (3-carene, myrcene and terpinolene) would be a better synergist for trans-verbenol and exo-brevicomin than myrcene alone.

### SUMMARY OF THE INVENTION

In general terms, the invention is directed to a method of employing monoterpene blends as synergists for the pheromones trans-verbenol and exo-brevicomin, wherein the blends are comprised of effective amounts of two or more compounds selected from the group consisting of: myrcene, terpinolene, (+)-3-carene, (+)-α-pinene, (−)-α-pinene, α-terpinene, γ-terpinene, (+)-camphene, (−)-camphene, (+)-sabinene, (−)-sabinene, (+)-β-pinene, (−)-β-pinene, p-cymene, dipentene, (+)-limonene, (−)-limonene, (−)-bornyl acetate, and β-phellandrene. More specifically, the effective monoterpene blends may be comprised of: myrcene and terpinolene, myrcene and (+)-3-carene, terpinolene and (+)-carene, or myrcene, terpinolene and (+)-3-carene. In combination with said pheromones, the novel blends of synergistic monoterpenes cause greater attraction of mountain pine beetles to lures than any monoterpene used alone, and result in a shift of the sex ratio of attracted beetles in favor of females.

This invention also pertains to a composition for synergizing the attraction of mountain pine beetles to pheromones, consisting essentially of an effective amount of a blend of two or more compounds selected from the group consisting of: myrcene, terpinolene, (+)-3-carene, (+)-α-pinene, (−)-α-pinene, α-terpinene, γ-terpinene, (+)-camphene, (−)-camphene, (+)-sabinene, (−)-sabinene, (+)-β-pinene, (−)-β-pinene, p-cymene, dipentene, (+)-limonene, (−)-limonene, (−)-bornyl acetate, and β-phellandrene, or more specifically blends of myrcene and terpinolene, myrcene and (+)-3-carene, terpinolene and (+)-3-carene, or myrcene, terpinolene and (+)-3-carene. Blends of monoterpenes selected from the above compositions can be combined in effective amounts with the pheromones trans-verbenol and exo-brevicomin to synergize the attraction of mountain pine beetles, and to shift the sex ratio in favor of females.

### DETAILED DESCRIPTION OF THE INVENTION

Past research and practice teaches that myrcene is the most effective monoterpene synergist for attraction of mountain pine beetles, Dendroctonus ponderosae, to the pheromone trans-verbenol alone or in combination with exo-brevicomin. No blend of monoterpenes has ever been shown to be a more effective synergist than any single monoterpene.

In contrast to these past teachings, we have discovered unexpectedly that blends of two or more monoterpenes will act as better synergists for attractive mountain pine beetle pheromones than any single monoterpene used alone. These monoterpene blends may be employed in a composition with attractive pheromones to improve the attraction of mountain pine beetles to traps where they will be killed, or to trees or stands where they can be removed by harvesting the infested trees. In accordance with this discovery, it is an object of this invention to provide compositions that may be used to enhance the use of semiochemicals in managing damaging infestations of the mountain pine beetle.

### EXAMPLE 1

Two synthetic blends of bole volatiles were made up. The lodgepole pine blend had the following composition: α-pinene [6.8%, 72.1% (−) enantiomer], camphene [3.9%, 64.1% (−) enantiomer], β-pinene [18.2%, 89.8% (−) enantiomer], myrcene (2.7%), (+)-3-carene (6.0%), p-cymene (1.6%), β-phellandrene (51.4%), limonene [8.2%, 72.8% (−) enantiomer], and terpinolene (1.0%). The whitebark pine blend had a composition as follows: α-pinene (2.5%), β-pinene (5.4%), (+)-3-carene (61.9%), myrcene (20.7%), limonene (2.7%) and terpinolene (6.8%). Where not specified, the enantiomeric compositions of the whitebark pine constituents were identical to those in the lodgepole pine blend. Both blends were loaded in 2.5 ml aliquots into closed 20 ml low-density polyethylene bottles, which released the volatiles at approximately 100 mg per day. Other test materials were myrcene (released from 20 ml polyethylene bottles as above), trans-verbenol [82% (−) enantiomer] released at approximately 1.5 mg per day from a bubble cap release device (Phero Tech Inc., Delta, B.C.), and (±)-exo-brevicomin released at approximately 0.3 mg per day from a polyurethane flexlure (Phero Tech Inc.).

Experiment 1 was set up in 2004 at Howes Lake, north of Williams Lake, B.C., with four replicates run from 6-22 July and four replicates from 4-17 August, and on the 108 Road, 9 km south of its junction with the 2300 Road, east of Williams Lake, with four replicates run from 6-22 July. Twelve-unit Lindgren multiple-funnel traps (Phero Tech Inc.) were placed at least 15 m apart along the margins of areas where lodgepole pines infested with the mountain pine beetle had been removed by harvesting prior to emergence of brood beetles in 2004. Some residual infested trees remained within the unharvested portions of the standing forest at both locations. The following treatments were assigned to traps in 12 randomized complete blocks: unbaited control, pheromone (one release device each for trans-verbenol and exo-brevicomin), and pheromone plus lodgepole pine volatiles, whitebark pine volatiles or myrcene (one bottle per treatment). Release devices were suspended from the trap legs below the fifth or sixth funnel from the top, and hung within the open central space within the funnel column.

Captured beetles were collected after the above durations, and held frozen in plastic bags until examined. All mountain pine beetles were counted, and the sex was determined for all beetles captured or a sample of 50 beetles per trap, whichever was least. When 50 beetles were sexed, the remaining count was divided by sex according to the proportions of each sex in the sample. Data were transformed by log₁₀(x+1), and subjected to ANOVA and the REWQ test for multiple comparison among means (α=0.05).

Both the whitebark pine blend and the lodgepole pine blend acted as synergists when combined with trans-verbenol and exo-brevicomin (Table 1). The effect was much greater than that previously observed for lodgepole pine foliage volatiles, and for females the synergistic effect of myrcene was not significantly greater than that of either reconstituted blend, which were not different from each other. For males, myrcene had a significantly stronger effect than either blend.

Despite, the lack of statistical significance in the effect of the two blends, there were 2.3 and 1.2 times more males and females, respectively, captured in traps with the whitebark pine blend than in traps with the lodgepole pine blend, possibly because there was 10.4, 7.6 and 4.0 times more 3-carene, myrcene and terpinolene, respectively, in the former than the latter blend. These observations suggest that the other components in the blends interfered with the bioactivity of these three compounds, and that if tested in binary or ternary compositions, they might out-compete myrcene. This hypothesis was tested in the next two examples.

TABLE 1
Catch of mountain pine beetle males and females in Exp. 1, Howes
Lake, B.C., 6-22 Jul. (4 replicates) and 4-17 Aug. 2004 (4 repli-
cates), and 108 Road B.C., 6-22 Jul. 2004 (4 replicates), N = 12.

| | Catch ranked by treatment | | | |
|---|---|---|---|---|
| | | Mean number | | Mean percent |
| Sex | Treatment | captured (±SE)^{a} | | female (±SE)^{b} |
| Males | Pheromone + myrcene | 394.7 ± 152.8 | a | — |
| | Pheromone + whitebark pine bole volatiles | 209.8 ± 114.5 | b | — |
| | Pheromone + lodgepole pine bole volatiles | 92.9 ± 41.2 | b | — |
| | Pheromone (trans-verbenol + exo-brevicomin) | 15.9 ± 8.6 | c | — |
| | Unbaited control | 2.7 ± 1.8 | d | — |
| Females | Pheromone + myrcene | 215.2 ± 92.5 | a | 36.2 ± 2.6 |
| | Pheromone + whitebark pine bole volatiles | 146.9 ± 68.8 | a | 45.3 ± 4.0 |
| | Pheromone + lodgepole pine bole volatiles | 124.4 ± 56.1 | a | 53.7 ± 2.6 |
| | Pheromone (trans-verbenol + exo-brevicomin) | 30.3 ± 15.5 | b | 57.7 ± 8.0 |
| | Unbaited control | 6.1 ± 3.7 | c | 44.6 ± 13.3 |

^{a}Means within sex followed by the same letter are not significantly different, REGW Q test on data transformed by log₁₀ (x + 1), P < 0.05.
^{b}No significant differences among percents female

### EXAMPLE 2

In Experiment 2, myrcene, terpinolene and 3-carene were tested alone and in an equal-part ternary blend as synergists for trans-verbenol and exo-brevicomin. All four monoterpene treatments were presented in full 20 ml polyethylene bottles. The experimental design, processing of trap catches and data analysis were as in Experiment 1. All 12 replicates were run at Howes Lake from 6-22 July 2004.

As expected, all three monoterpenes alone acted as synergists for the pheromones, each resulting in significantly higher trap catches for both sexes than to the pheromones alone (Table 2). For males, myrcene was a significantly better synergist than 3-carene, and for females, terpinolene replaced myrcene in this order. A striking and novel result was unexpectedly obtained with the ternary blend, which provided a significantly greater synergistic effect than any of the components alone for males, and for females a significantly greater effect than for myrcene or 3-carene. The catch with the ternary blend was 1.9 times better than with myrcene for males and 3.3 times better for females. This is the first time that any monoterpene blend has been shown experimentally to be a better synergist than any monoterpene alone for mountain pine beetle pheromones. A further benefit of adding terpinolene and 3-carene to myrcene was that the sex ratio rose significantly from two-thirds male to approximately equal numbers of both sexes.

TABLE 2
Catch of mountain pine beetle males and females in Exp. 2, Howes Lake,
B.C., 6-22 Jul. 2004. N = 12.

| | Catch ranked by treatment | | | | |
|---|---|---|---|---|---|
| | | Mean number | | Mean percent | |
| Sex | Treatment | captured (±SE)^{a} | | female (±SE)^{a} | |
| Males | Pheromone + myrcene + terpinolene + 3-carene | 2180.1 ± 357.5 | a | — | |
| | Pheromone + myrcene | 1146.8 ± 293.4 | b | — | |
| | Pheromone + terpinoline | 627.3 ± 142.1 | bc | — | |
| | Pheromone + 3-carene | 329.3 ± 53.0 | c | — | |
| | Pheromone control | 75.7 ± 34.5 | d | — | |
| Females | Pheromone + myrcene + terpinolene + 3-carene | 2167.3 ± 388.2 | a | 48.7 ± 2.5 | b |
| | Pheromone + terpinolene | 1192.8 ± 289.3 | ab | 64.3 ± 2.0 | a |
| | Pheromone + myrcene | 653.2 ± 164.6 | bc | 33.7 ± 2.8 | c |
| | Pheromone + 3-carene | 376.1 ± 71.3 | c | 49.0 ± 3.6 | b |
| | Pheromone control | 102.1 ± 38.8 | d | 59.0 ± 2.5 | a |

^{a}Means within sex followed by the same letter are not significantly different, REGW Q test on data transformed by log₁₀ (x + 1), P < 0.05.

### EXAMPLE 3

Experiment 3 at Howes Lake tested all three possible equal-part binary blends and the equal-part ternary blend of myrcene, terpinolene and 3-carene as potential new synergists for trans-verbenol and exo-brevicomin. The experimental design, processing of trap catches and data analysis were as in Experiments 1 and 2. The experiment ran from 23 Jul. to 4 Aug. 2004, with the following treatments: pheromone control (trans-verbenol and exo-brevicomin), and pheromone plus myrcene, mrycene and 3-carene, myrcene and terpinolene, 3-carene and terpinolene, or myrcene, terpinolene and 3-carene. All monoterpenes were released as above from full 20 ml polyethylene bottles, except for the ternary blend, which was re-used from Experiment 2, and was approximately one-third depleted at the start of the experiment.

Compared to myrcene alone, the binary blend of myrcene and terpinolene unexpectedly resulted in significantly higher catches of both sexes (Table 3), 2.7 and 4.0 times greater for males and females, respectively. This was a better performance than for the ternary blend in Experiment 2. The other two binary blends were both synergistic for both sexes, but none was better than the ternary blend. The sex ratio for myrcene and terpinolene again shifted in favor of females, but in this case was not significantly higher than with myrcene alone. This is the first time that a binary blend of monoterpenes has been shown experimentally to be a better synergist for mountain pine beetle pheromones than any monoterpene alone.

TABLE 3
Catch of mountain pine beetle males and females in Exp. 3, Howes Lake,
B.C., 23 Jul.-4 Aug. 2004, N = 12.

| | Catch ranked by treatment | | | | |
|---|---|---|---|---|---|
| | | Mean number | | Mean percent | |
| Sex | Treatment | captured (±SE)^{a} | | female (±SE)^{a} | |
| Males | Pheromone + myrcene + terpinolene | 2123.3 ± 353.6 | a | — | |
| | Pheromone + myrcene + 3-carene | 1015.2 ± 178.1 | b | — | |
| | Pheromone + myrcene + terpinolene + 3-carene | 859.4 ± 140.0 | b | — | |
| | Pheromone + myrcene | 773.0 ± 136.2 | b | — | |
| | Pheromone + terpinolene + 3-carene | 637.6 ± 147.5 | b | — | |
| | Pheromone control | 68.6 ± 50.3 | c | — | |
| Females | Pheromone + myrcene + terpinolene | 1543.9 ± 235.6 | a | 41.5 ± 2.3 | bc |
| | Pheromone + terpinolene + 3-carene | 903.3 ± 265.8 | ab | 56.5 ± 2.8 | a |
| | Pheromone + myrcene + terpinolene + 3-carene | 775.0 ± 137.4 | ab | 46.0 ± 2.9 | ab |
| | Pheromone + myrcene + 3-carene | 731.1 ± 181.9 | ab | 38.2 ± 3.3 | bc |
| | Pheromone + myrcene | 385.3 ± 83.5 | b | 31.3 ± 3.5 | c |
| | Pheromone control | 95.3 ± 69.5 | c | 56.3 ± 4.0 | a |

^{a}Means within sex followed by the same letter are not significantly different, REGW Q test on data transformed by log₁₀ (x + 1), p < 0.05.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

### REFERENCES

### Foreign Patent Documents

Canadian Patent No. 1212044 September 1986

### Publications

Billings, R. F., R. I. Gara and B. F. Hrutfiord. 1976. Influence of ponderosa pine resin volatiles on the response of Dendroctonus ponderosae to synthetic trans-verbenol. Environ. Entomol. 5: 171-179.
Borden, J. H., J. E. Conn, L. M. Friskie, B. E. Scott, L. J. Chong, H. D. Pierce, Jr. and A. C. Oehlschlager. 1983. Semiochemicals for the mountain pine beetle, Dendroctonus ponderosae (Coleoptera: Scolytidae), in British Columbia: baited tree studies. Can. J. For. Res. 13: 325-333.
Borden, J. H., L. C. Ryker, L. J. Chong, H. D. Pierce, Jr., B. D. Johnston and A. C. Oehlschlager. 1987. Response of the mountain pine beetle, Dendroctonus ponderosae Hopkins (Coleoptera: Scolytidae), to five semiochemicals in British Columbia lodgepole pine forests. Can. J. For. Res. 17: 118-128.
Borden, J. H., L. J. Chong, B. S. Lindgren, E. J. Begin, T. M. Ebata, L. E. Maclauchlan and R. S. Hodgkinson. 1993. A simplified tree bait for the mountain pine beetle. Can. J. For. Res. 23: 1108-1113.
Conn, J. E., J. H. Borden, B. E. Scott, L. M. Friske, H. D. Pierce, Jr. and A. C. Oehlschlager. 1983. Semiochemicals for the mountain pine beetle, Dendroctonus ponderosae (Coleoptera: Scolytidae) in British Columbia: field trapping studies. Can. J. For. Res. 13: 320-324.
Libbey, L. M., L. C. Ryker and K. L. Yandell. 1985. Laboratory and field studies of volatiles released by Dendroctonus ponderosae Hopkins (Coleoptera, Scolytidae). Z. angew. Entomol. 100: 381-392.
McKnight, R. C. 1979. Differences in response among populations of Dendroctonus ponderosae Hopkins to its pheromone complex. M.Sc. thesis, University of Washington, Seattle.
Miller, D. R. and J. H. Borden. 1990. β-Phellandrene: kairomone for pine engraver, Ips pini (Say) (Coleoptera: Scolytidae). J. Chem. Ecol. 16: 2519-2531.
Miller, D. R. and J. H. Borden. 2000. Dose-dependent and species-specific responses of pine bark beetles (Coleoptera: Scolytidae) to monoterpenes in association with pheromones. Can. Entomol. 132: 183-195.
Pitman, G. B. 1971. trans-Verbenol and alpha-pinene: their utility in manipulation of the mountain pine beetle. J. Econ. Entomol. 64: 426-430.
Pitman, G. B. and J. P. Vité. 1969. Aggregation behavior of Dendroctonus ponderosae (Coleoptera: Scolytidae) in response to chemical messengers. Can. Entomol. 101: 143-149.
Pitman, G. B., J. P. Vité, G. W. Kinzer and A. F. Fentiman, Jr. 1968. Bark beetle attractants: trans-verbenol isolated from Dendroctonus. Nature 218: 168-169.
Pureswaran, D. S. 2003. The role of kairomones and pheromones in host selection by tree-killing bark beetles (Coleoptera: Scolytidae). Ph.D. thesis, Simon Fraser University, Burnaby B.C., Canada.
Pureswaran, D. S. and J. H. Borden. 2005. Primary attraction and kairomonal host discrimination in three species of Dendroctonus (Coleoptera: Scolytidae). Agric. For. Entomol. 7:219-230.
Rudinsky, J. A., M. E. Morgan, L. M. Libbey and T. B. Putnam. 1974. Antiaggregative-rivalry pheromone of the mountain pine beetle, and a new arrestant of the southern pine beetle. Environ. Entomol. 3: 90-98.
Seybold, S. J. 2002. Development of a monitoring and management tool for the central Rocky Mountain populations of the mountain pine beetle, Dendroctonus ponderosae. Prog. Rep., Proj. No. R4-2001-01. USDA For. Serv., Pac. SW Res. Sta., Davis, Calif.
Shrimpton, D. M. 1973. Extractives associated with wound response of lodgepole pine attacked by the mountain pine beetle and associated microorganisms. Can. J. Bot. 51: 527-534.
Smith, R. H. 2000. Xylem monoterpenes of pines: distribution, variation, genetics, function. USDA For. Serv., Gen. Tech. Rep. PSW-GTR-177.

What is claimed is:

1. A method of employing a blend of monoterpenes as a synergist for attractive pheromones of the mountain pine beetle, Dendroctonus ponderosae, wherein the blend is comprised of an effective amount of two or more compounds selected from the group consisting of: myrcene, terpinolene, (+)-3-carene, (+)-α-pinene, (−)-α-pinene, α-terpinene, γ-terpinene, (+)-camphene, (−)-camphene, (+)-sabinene, (−)-sabinene, (+)-β-pinene, (−)-β-pinene, p-cymene, dipentene, (+)-limonene, (−)-limonene, (−)-bornyl acetate, and β-phellandrene.

2. The method of claim 1, wherein the monoterpene blend consists of an effective amount of: myrcene and terpinolene, myrcene and (+)-3-carene, terpinolene and (+)-carene, or myrcene, terpinolene and (+)-3-carene.

3. The method of claim 1 wherein the pheromone is trans-verbenol.

4. The method of claim 1 wherein the pheromone is a combination of trans-verbenol and exo-brevicomin.

5. The method of claim 1, wherein the monoterpene blend and pheromones are deployed in traps.

6. The method of claim 1, wherein the monoterpene blend and pheromones are deployed on pine trees.

7. The method of claim 1, wherein the monoterpene blend and pheromones are deployed in the vicinity of pine trees.

8. A composition for synergizing the attraction of mountain pine beetles, Dendroctonus ponderosae, to pheromones, consisting essentially of an effective amount of a blend of two or more compounds selected from the group consisting of: myrcene, terpinolene, (+)-3-carene, (+)-α-pinene, (−)-α-pinene, α-terpinene, γ-terpinene, (+)-camphene, (−)-camphene, (+)-sabinene, (−)-sabinene, (+)-β-pinene, (−)-β-pinene, p-cymene, dipentene, (+)-limonene, (−)-limonene, (−)-bornyl acetate, and β-phellandrene.

9. The composition of claim 8, wherein the blend consists of an effective amount of:
myrcene and terpinolene, myrcene and (+)-3-carene, terpinolene and (+)-3-carene, or myrcene, terpinolene and (+)-3-carene.

10. The composition of claim 8 wherein the pheromone is trans-verbenol.

11. The composition of claim 8 wherein the pheromone is a combination of trans-verbenol and exo-brevicomin.
